(19) United States
(12) Patent Application Publication
(10) Pub. No.: US 2014/0057814 A1
(43) Pub. Date: Feb. 27, 2014

(54) GUM ARABIC ENCAPSULATION OF REACTIVE PARTICLES FOR ENHANCED DELIVERY DURING SUBSURFACE RESTORATION

(71) Applicants: Tao Long, Medford, MA (US); C. Andrew Ramsburg, Reading, MA (US)

(72) Inventors: Tao Long, Medford, MA (US); C. Andrew Ramsburg, Reading, MA (US)

(73) Assignee: TUFTS UNIVERSITY, Medford, MA (US)

(21) Appl. No.: 13/991,934

(22) PCT Filed: Dec. 6, 2011
(86) PCT No.: PCT/US11/63417

§ 371 Date: Nov. 13, 2013

Related U.S. Application Data
(60) Provisional application No. 61/420,607, filed on Dec. 7, 2010.

(51) Int. Cl. C09K 8/536

(52) U.S. Cl. CPC C09K 8/536
USPC 507/211

(57) ABSTRACT

The present invention relates to emulsion compositions comprising iron particles (e.g., nanoscale zero valent iron particles) and methods of use thereof for remediation of contaminated environmental sites (e.g., contaminated subsurface environments).

This application claims priority to provisional patent application 61/420,607, filed Dec. 7, 2010, which is herein incorporated by reference in its entirety.

### FIELD OF THE INVENTION

The present invention relates to remediation of contaminated environmental sites. In particular, the present invention relates to encapsulated reactive particle compositions and methods of use for remediation (e.g., of contaminated subsurface environments).

### BACKGROUND OF THE INVENTION

Nonaqueous phase liquids (NAPLs) are present at numerous hazardous waste sites and are suspected to exist at many more. NAPL is a term used to describe the physical and chemical differences between a hydrocarbon liquid and water which result in a physical interface between two liquid phases. The interface is a physical dividing surface between the bulk phases of the two liquids. Components (solutes) in either phase may partition (dissolve) between phases. With respect to contaminated sites, the NAPL typically represents an organic phase which slowly dissolves into the groundwater moving through the source area (the region of a site containing NAPL).

Nonaqueous phase liquids have typically been divided into two general categories, dense (abbreviated as Dense Nonaqueous Phase Liquids, or DNAPLs) and light (abbreviated as Light Nonaqueous Phase Liquids, or LNAPLs). These terms describe the specific gravity, or the density of the nonaqueous phase liquid relative to that of the site groundwater. Correspondingly, DNAPLs have specific gravities greater than that of water, and LNAPLs have specific gravities less than that of water. Due to the numerous variables influencing NAPL transport and fate in the subsurface, and consequently, the ensuing complexity, NAPLs are largely undetected and yet are a significant limiting factor in site remediation.

The general chemical categories of NAPLs are halogenated/non-halogenated semi-volatiles and halogenated volatiles. These compounds are typically found in the following wastes and waste-producing processes: industrial dry cleaning and degreasing operations, wood preserving wastes (creosote, pentachlorophenol), fuel refining, transport and storage, production of manufactured gas (e.g., coal tars), and pesticide manufacturing. The most frequently cited group of these contaminants to date are the chlorinated solvents. The U.S. Environmental Protection Agency cites trichloroethene, polychlorinated biphenyls (PCBs), bunker C oil, and chlorobenzene as among the most widely distributed DNAPLs (Zogorski et al. (2006) USGS Circular 1292). For example, trichloroethene constitutes the most frequently detected volatile organic compound at Superfund sites; PCBs occurs at over 500 Superfund sites; the marine diesel fuel bunker C oil is a major contaminate in beach and sea floor sites, and chlorobenzene has been detected at 97 Superfund sites (Zogorski et al. (2006) USGS Circular 1292).

Because of the way DNAPLs move and distribute themselves in the subsurface they are particularly difficult to detect and remediate. Depending upon the source zone architecture (spatial distribution of DNAPL) and location (e.g., above or below the water table, in deep or shallow unconsolidated soils or fractured bedrock), different treatment approaches may be appropriate. In the past, unless the source zone was amenable to excavation and treatment or to removal by soil vapor extraction, it was either recovered to the extent practicable or given a technical impracticability waiver and left in place with some form of containment system to prevent offsite migration of contaminated ground water.

Additional methods are needed in remediation of NAPL source zones. Particularly needed are cost-effective methods that reduce contaminant discharge from the source zone. Methods compatible with pH adjustment (e.g., alkalinity addition) find particular use.

### SUMMARY OF THE INVENTION

The present invention relates to remediation of contaminated environmental sites. In particular, the present invention relates to encapsulated reactive particle compositions and methods of use thereof for remediation (e.g., of contaminated subsurface environments).

Nanoscale zero-valent iron (nZVI) particles find use in remediation of contaminated environments due to their reactivity and amenability to in situ treatment. Stabilization of reactive iron particles against aggregation and sedimentation is an important engineering aspect for successful application of nanoscale zero valent iron (nZVI) within the contaminated subsurface environment. In experiments conducted during the course of developing some embodiments of the present invention, novel nZVI encapsulation strategies were developed, leading to new emulsion compositions that possess superior stability and reactivity profiles. In some embodiments, encapsulation methods of embodiments of the present invention rely upon Gum arabic to stabilize high quantities of iron (˜12 g/L) in the dispersed phase of a soybean oil-in-water emulsion. In some embodiments, the emulsion is stable against coalescence due to substantial repulsive barriers to droplet-droplet contact and droplet-droplet induced deformation. In some embodiments, emulsion compositions of the present invention possess sedimentation time scales on the order of hours (τ=4.77±0.02 hr). The Gum arabic-stabilized, iron-containing, oil in water emulsion is an advance in nZVI stabilization. In experiments conducted during the course of developing some embodiments of the present invention, iron within the emulsion was reactive with both trichloroethane (TCE) degradation and H₂ production observed. The surface normalized, pseudo first-order rate coefficient determined for TCE consumption within the oil phase ((1.5±0.1)×10⁻⁵ Lₒᵢₗ·hr⁻¹ m⁻²) produced rates that were of the same order of magnitude as those reported for less stable, aqueous suspensions of iron particles.

Emulsion compositions of embodiments of the present invention are not limited by the concentration of iron (e.g., nZVI) particles. Emulsion compositions may comprise, for example, less than 0.5 g/L, 0.5-1 g/L, 1-2 g/L, 2-3 g/L, 3-4 g/L, 4-5 g/L, 5-6 g/L, 6-7 g/L, 7-8 g/L, 8-9 g/L, 9-10 g/L, 10-11 g/L, 11-12 g/L, 12-13 g/L, 13-14 g/L, 14-15 g/L, 15-20 g/L, or over 20 g/L iron. In some preferred embodiments, emulsion compositions comprise 3 g/L iron or more. In some particularly preferred embodiments, emulsion compositions comprise 10 g/L iron or more.

In some preferred embodiments, emulsion compositions of the present invention comprise iron particles (e.g., zero valent iron particles, nanoscale zero valent iron particles, microscale zero valent iron particles), a nonpolar phase, a polar phase, and an amphipathic phase. In some preferred embodiments, the iron particle is a nanoscale zero valent iron particle (nZVI). Iron particles are not limited by size, shape, or purity. Iron particles may be less than 5 nm in diameter, 5-10 nm, 10-20 nm, 20-50 nm, 50-100 nm, 100 nm-1 μm, 1-5 μm, 5-10 μm, 10-25 μm, 25 μm or more in diameter. In preferred embodiments, iron particles are nanoscale (e.g., having diameters of less than 1 μm). Iron particles may be regular (e.g., spherical, ellipsoid, cuboidal) or irregular in shape. The macroscopic appearance of iron particle components of emulsion compositions of embodiments of the present invention prior to formation of said emulsions may be granular, powdered, milled, or the like. Emulsion compositions are not limited by iron particle (e.g., nZVI, ZVI) type. In some embodiments, Reactive Nanoscale Iron Particles (RNIPs) are used. RNIPs consist of an elemental iron core (α-Fe) and a magnetite shell (Fe₃O₄). In some embodiments, iron particles are synthesized by alkaline treatment of ferrous solution (e.g., by treating FeSO₄ (e.g., FeSO₄.7H₂O) with NaOH followed by exposure to NaBH₄). In some embodiments, reactive iron particles are produced via borohydride reduction (Glavee et al., 1995; herein incorporated by reference in its entirety). In some embodiments, submicron iron particles are utilized. In some embodiments, MTI iron products are utilized. MTI iron particles comprise an iron core with a small oxide layer on the outside. In some embodiments, MTI iron particles are formed using plasma chemical vapor deposition.

Emulsion compositions are not limited by the encapsulation methods employed for their formation. In preferred embodiments, oil-in-water emulsions are formed. In particularly preferred embodiments, oil-in-water emulsions comprise an amphipathic phase, e.g., serving to encapsulate an oil phase. In particularly preferred embodiments, an amphipathic phase is formed by a Gum arabic film.

In preferred embodiments, emulsion compositions comprise a nonpolar phase. In preferred embodiments, the nonpolar phase comprises oil (e.g., vegetable oil, soybean oil). In particularly preferred embodiments, the nonpolar phase comprises soybean oil without limitation to composition (e.g., fatty acid composition). In preferred embodiments, emulsion compositions comprise oleic acid.

Emulsion compositions of embodiments of the present invention find use in environmental remediation, e.g., remediation of contaminated subsurfaces, without limitation to contaminant, site, or method of application. In some embodiments, contaminants comprise one or more non-aqueous phase liquids (NAPL). In some embodiments, the non-aqueous phase liquid is a dense non-aqueous phase liquid (DNAPL). In some embodiments, the environmental contaminant is a halogenated methane, ethane, ethene or benzene (e.g., halogenated with carbon tetrachloride, chloroform, trichloroethene, or trichloroethane). Examples of contaminants suitable for remediation using compositions and methods of the present invention include, but are not limited to, halogenated methanes, ethanes, ethenes and benzenes (e.g. carbon tetrachloride, chloroform, trichloroethene, trichloroethane), chromium (Cr₂O₇⁻), arsenic (AsO₄3−) and mercury (Hg²⁺). ZVIs degrade perchlorate (ClO₄⁻) to chloride. In some embodiments, the NAPL comprises more than one distinct environmental contaminant.

In certain embodiments, the present invention provides an emulsion composition comprising nanoscale zero valent iron (nZVI) particles, soybean oil, and gum arabic, wherein the concentration of Fe⁰ in the emulsion is at least 3 g/L. In some embodiments, the emulsion has density between 0.95 and 1.05 g/mL and viscosity <20 cP. In some embodiments, the emulsion composition is free of surfactants. In some embodiments, the concentration of Fe⁰ in the emulsion is at least 10 g/L. In some embodiments, the nZVI particles are uncoated. In some embodiments, the emulsion exhibits a sedimentation time of 4 hours or greater.

In certain embodiments, the present invention provides a method of neutralizing environmental contaminants within non-aqueous phase liquid comprising contacting a non-aqueous phase liquid (NAPL) comprising an environmental contaminant with an emulsion composition comprising nanoscale zero valent iron (nZVI) particles, soybean oil, and gum arabic, wherein the concentration of Fe⁰ in the emulsion is at least 3 g/L. In some embodiments, the contacting causes chemical reduction of the environmental contaminant within the NAPL. In some embodiments, the NAPL is a dense non-aqueous phase liquid (DANPL). In some embodiments, the environmental contaminant is a type such as a halogenated methane, ethane, ethene or benzene. In some embodiments, the halogenated group is a type such as carbon tetrachloride, chloroform, trichloroethene, or trichloroethane. In some embodiments, the environmental contaminant is dechlorinated. In some embodiments, the NAPL comprises more than one distinct environmental contaminant.

Additional embodiments will be apparent to persons skilled in the relevant art based on the teachings contained herein.

### DESCRIPTION OF THE DRAWINGS

FIG. 1 shows emulsion viscosity of one embodiment of the present invention as measured at 20.00±0.01° C. Error bars represent standard error of triplicate measurements.

FIG. 2 shows trapping number regions (a) defining zones of little, no and complete mobilization for a GA-containing emulsion of embodiments of the present invention and (b) showing the line representing complete mobilization for several flushing solutions.

FIG. 3 shows a GA stabilized, iron containing, oil-in-water emulsion embodiment of the present invention: (a) photograph; light microscopy images of the suspended (b) and sedimented (c) fractions (with 10 μm scale bar); conceptual diagram of (d) adsorption of GA to iron oil (Dickinson (2003) Food Hydrocolloids 17:25-39; herein incorporated by reference in its entirety), and (e) stabilized droplet.

FIG. 4 shows droplet size distributions over the period of 1 day plotted on a number (a) and volume (b) basis.

FIG. 5 shows emulsion stability assessment at 580 nm. Fit of Equation 1 and related 95% prediction interval is shown.

FIG. 6 shows a schematic for DLVO calculations for deformable droplets (after Petsev et al. (1995) J. Colloid Interface Sci. 176:201-213; herein incorporated by reference in its entirety).

FIG. 7 shows sedimentation data and model fit with time constants for the two settling populations. See Example 1 for details on sedimentation model.

FIG. 8 shows reaction data and kinetic model fit for TCE transformation by a GA stabilized emulsion embodiment of the present invention. Error bars represent standard error of triplicate reactors. Headspace data and model fits for TCE (filled circles, top graph) and hydrogen (filled circles, bottom graph). Control reactors included absence of iron (gray squares, top and bottom graphs) and absence of TCE (gray diamonds, bottom graph). TCE and hydrogen data were simultaneous fit (solid lines) as described in SI. Ethane data (gray triangles, top graph) are shown with predicted concentration (dashed line) from hydrogenation reaction fit to TCE and hydrogen data.

### DEFINITIONS

To facilitate an understanding of the present invention, a number of terms and phrases are defined below:

As used herein, the term “environmental contaminant” refers to any compound not naturally found in a given environment (e.g., harmful to the environment or animals (e.g., humans)). In some embodiments, environmental contaminants are found in NAPLs. In some embodiments, environmental contaminants are solvents or industrial byproducts (e.g., including but not limited to, halogenated methanes, ethanes, ethenes and benzenes (e.g. carbon tetrachloride, chloroform, trichloroethene, trichloroethane modified benzenes)). In some embodiments, the environmental contaminant is trichloroethene.

As used herein, the term “neutralizing environmental contaminants” refers to the process of altering environmental contaminants to result in products that are no longer harmful to the environment or animals (e.g., humans). In some embodiments, the process of neutralizing environmental contaminants includes dechlorination (e.g., by using ZVI or nZVI particles).

As used herein, the term “zero-valent metal” means any composition, mixture or coated product which includes a zero-valent metal, as well as meaning a zero-valent metal in its pure form.

As used herein, the term “nanoscale zero valent iron” or “zero valent iron” refers to particulate iron metal, e.g., comprising elemental iron (Fe⁰). In preferred embodiments, average particle diameter is submicron (e.g., less than 1 μm in diameter).

### DETAILED DESCRIPTION OF THE INVENTION

When suspended within an aqueous phase, nZVI particles tend to rapidly agglomerate due to the dominance of attractive, magnetic forces (Phenrat et al. (2007) Environ. Sci. Technol. 41:284-290; herein incorporated by reference in its entirety). Aggregation increases particle settling and leads to greater particle retention. Thus, the principle limitation to application of nZVI within the subsurface remediation is particle transport. To overcome this limitation several classes of stabilization mechanisms have been developed including: grafting of high molecular materials to the surface of nZVI particles (He et al. (2007) Environ. Sci. Technol. 41:6216-6221; Phenrat et al. (2008) J. Nanopart. Res. 10:795-814; Sun et al. (2007) Colloids and Surfaces a-Physico. Engineer. Aspects 308:60-66; Tiraferri et al. (2008) J. Colloid Interface 324:71-79; each herein incorporated by reference in its entirety); coating Fe⁰ on the surface of non-magnetic carrier materials (Schrick et al. (2004) Cem. Mat. 16:2187-2193; Zheng et al. (2008) Environ. Sci. Technol. 42:4494-4499; Zhan et al. (2009) 43:8616-8621; each herein incorporated by reference in its entirety); and encapsulation of nZVI within transport vessels (Quinn et al. (2005) Environ. Sci. Technol. 39:1309-1318; Berge et al. (2009) Environ. Sci. Technol. 43:5060-5066; each herein incorporated by reference in its entirety). Encapsulation of reactive iron particles was first accomplished by Quinn et al ((2005) Environ. Sci. Technol. 39:1309-1318) using a liquid membrane system in which iron particles are located within aqueous droplets (˜12 microns) coated by an oil film. While the hydrophobic membrane employed in this water-in-oil-in-water emulsion increases contaminant selectivity, iron particles remain exposed to water where corrosion reactions consume ZVI. In addition, the viscosity of the resulting emulsion (˜1900 cp) makes transport though porous media energy intensive, where it is even applicable (flow of viscous fluids through low permeability silts and clays, for example, may be impracticable). Soybean oil-in-water emulsions can be used to encapsulate the reactive particles for delivery in fine sand at Darcy velocities that are readily maintained in shallow, unconfined DNAPL source zones (Berge et al. (2009) Environ. Sci. Technol. 43:5060-5066; herein incorporated by reference in its entirety). The ability to transport well-designed oil-in-water emulsions through porous media with modest energy input (Coulibaly et al. (2004) J. Contam. Hydrol. 71:219-237; Borden et al. (2007) J. Contam. Hydrol. 94:1-12; each herein incorporated by reference in its entirety) highlights a key advantage of encapsulated delivery as the use of aqueous suspensions of iron particles typically relies upon Darcy velocities on the order of 10-100 m/d to maintain particle transport (Berge et al. (2009) Environ. Sci. Technol. 43:5060-5066; herein incorporated by reference in its entirety). Encapsulation of iron particles within a nonpolar phase may also limit the oxidation of Fe⁰ by water (and non-target solutes) which can cause significant loss of nZVI effectiveness (Tratnyek et al. (2006) Nano Today 1:4-48; herein incorporated by reference in its entirety). Encapsulation strategies, however, should be carefully designed to control reactivity. Recently, Berge and Ramsburg (Berge et al. (2009) Environ. Sci. Technol. 43:5060-5066; Coulibaly et al. (2004) J. Contam. Hydrol. 71:219-237; Borden (2007) J. Contam. Hydrol. 94:1-12; Tratnyek et al. (2006) Nano Today 1:44-48; each herein incorporated by reference in its entirety) have demonstrated the capability for iron particles to degrade chlorinated solvents within organic phases when water is available as a solute within the organic phase. The stability of the iron containing (2.5 g/L) oil-in-water emulsion created by Berge and Ramsburg (Berge et al. (2009) Environ. Sci. Technol. 43:5060-5066; herein incorporated by reference in its entirety), however, utilized coating the iron particles prior to incorporation within the non-polar phase and the use of two surfactants to stabilize the oil-water interface. The combination of modest stability and the fact that surface coatings have been found to reduce the reactivity of nZVI by about an order or magnitude (Phenrat et al. (2008) J. Nanopart. Res. 10:795-814; herein incorporated by reference in its entirety) limited the utility of such emulsions.

In some embodiments of the present invention, Gum Arabic (GA), a natural, food-grade product (Dickinson (2003) Food Hydrocolloids 17:25-39; herein incorporated by reference in its entirety), was used to stabilize a soybean oil-in-water emulsion containing a high concentration (˜10 g/L) of uncoated, nZVI particles. Experimental and theoretical assessments of stability were completed within the context of maintaining reactivity (with a model contaminant, trichloroethene) at rates comparable to those observed for aqueous suspensions of reactive iron particles.

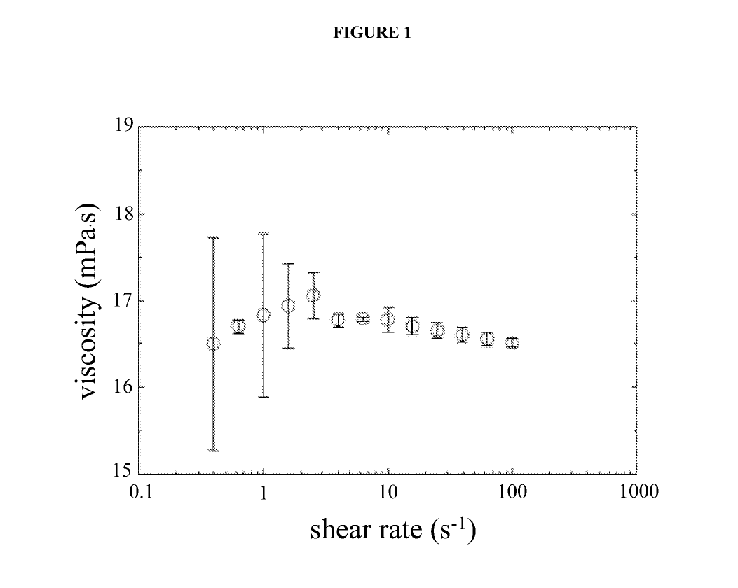

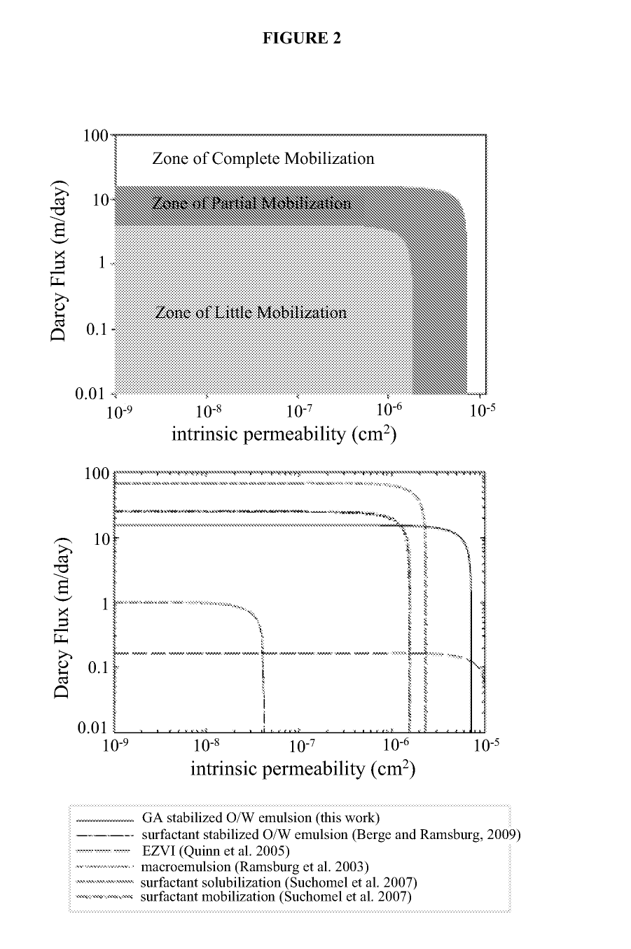

Overall the GA emulsion of some embodiments of the present invention allows an advance in stabilizing high quantities of nZVI particles for transport in porous media while maintaining particle reactivity at rates that are consistent with polymer coated particles. Droplet sizes on the order of a micron have been shown to be mobile within fine sand due to limited potential for straining (Berge et al. (2009) Environ. Sci. Technol. 43:5060-5066; Coulibaly et al. (2004) J. Contam. Hydrol. 71:219-237; Borden et al. (2007) J. Contam. Hydrol. 94:1-12; each herein incorporated by reference in its entirety). Moreover, the net negative charge on the emulsion droplets and the ability for gentle mixing to maintain the kinetic stability indicate that the GA emulsion is readily transported within porous media. The combination of the relatively high IFT with TCE-NAPL (30.75±0.02 mN/m) and modest viscosity (16.8±0.1 mPa-s at 10 s⁻¹ and 20.00±0.01° C., see FIG. 1) show that the GA emulsion offers potential for mobilizing DNAPL during delivery (FIG. 2).

The materials employed to create the emulsion (GA, soybean oil, oleic acid) are food-grade, commodity chemicals and enhance the synergy between iron-based reductive dechlorination and metabolic reductive dechlorination; particularly since encapsulation of iron sequesters the chemical and biological reactions (Bordon et al. (2007) J. Contam. Hydrol. 94:1-12; Kirschling et al. (2010) Environ. Sci. Technol. 44:3474-3480; Xiu et al. (2010) Bioresour. Technol. 101:1141-1146; each herein incorporated by reference in its entirety). Immersion of the iron within oil immediately following particle synthesis protects the Fe⁰ from oxidation by atmospheric oxygen and reaction with water, indicating limited decline in ZVI content during longer-term storage. Because the reaction occurs in a non-aqueous phase (oil or NAPL), the availability of dissolved water is important and represents a tradeoff between TCE consumption and H₂ production (Berge et al. (2010) J. Contamin. Hydrol. 2010).

Soybean Oil

Some emulsion embodiments of the present invention comprise nonpolar liquid, without limitation to the type of liquid. In preferred embodiment, the liquid is oil. In particularly preferred embodiments, the liquid is soybean oil. A typical method for production of soybean oil involves cracking the soybeans, adjusting for moisture content, heating to between 140° F. and 190° F., rolling the cracked soybeans into flakes, and solvent-extracting the material with hexane. The oil is then refined and blended for different applications. The major unsaturated fatty acids in soybean oil triglycerides are 7% alpha-Linolenic acid (C-18:3); 51% linoleic acid (C-18:2); and 23% oleic acid (C-18:1). It also contains the saturated fatty acids 4% stearic acid and 10% palmitic acid. In some embodiments, the presence of organic acids in soybean oil finds use in promotion of iron dissolution and complexation (Berge et al. (2009) Environ. Sci. Technol. 43:5060-5066; herein incorporated by reference in its entirety). In some embodiments, oils with different compositions of fatty acids are used.

Soybean oil has a relatively high proportion, 7-10%, of oxidation-prone linolenic acid, which may affect stability of the oil for various applications. In some embodiments, soybean oils with low linolenic acid are utilized. Soybean oils with low linolenic acid content have been developed by commercial and academic entities (e.g., researchers at Iowa State University; Monsanto Company, DuPont/Bunge, Asoyia).

nZVI Types and Methods of Synthesis

Emulsion compositions of the present invention are not limited to a particular type of ZVI (e.g., nZVI). In some embodiments, Reactive Nanoscale Iron Particles (RNIPs) are used. RNIP (RNIP) consists of an elemental iron core (α-Fe) and a magnetite shell (Fe₃O₄). RNIP may be produced using any number of known methods. In some embodiments, the method described in Toda Kogyo Corporation's patent (Uegami et al., U.S. Patent 2003/0217974 A1; herein incorporated by reference) is utilized. The starting material for RNIP is an aqueous solution of purified ferrous sulfate (FeSO₄). Ferrous iron is crystallized and oxidized to form the ferric oxyhydroxide goethite (α-FeO(OH)). Goethite is dehydrated to hematite (Fe₂O₃). Hematite is reduced to elemental iron (α-Fe) with hydrogen gas (H₂). The elemental iron particles are wet milled and dispersed in water thereby the particle surfaces convert to magnetite (Fe₃O₄).

In some embodiments, reactive iron particles are produced via borohydride reduction (Glavee et al., 1995; herein incorporated by reference in its entirety). In preferred embodiments, submicron iron particles are utilized. In some embodiments, MTI iron products are utilized. MTI iron particles comprise an iron core with a small oxide layer on the outside. In some embodiments, MTI iron particles are formed using plasma chemical vapor deposition.

Types of Environmental Contamination

The present invention is not limited to the remediation of a particular solvent or environmental contaminant. Examples of contaminants suitable for remediation using compositions and methods of the present invention include, but are not limited to, halogenated methanes, ethanes, ethenes and benzenes (e.g. carbon tetrachloride, chloroform, trichloroethene, trichloroethane), chromium (Cr₂O₇⁻), arsenic (AsO₄³⁻) and mercury (Hg²⁺). ZVIs degrade perchlorate (ClO₄⁻) to chloride.

Remediation Methods

The compositions of embodiments of the present invention find use in the remediation of contaminants (e.g., halogenated contaminants) in NAPLs (e.g., DNAPLs) using ZVI particles (e.g., nZVI particles) or other chemistry. In some embodiments, ZVI emulsion compositions of embodiments of the present invention are applied to the surface of a source zone and diffuse into the NAPL. In other embodiments, emulsion compositions are administered directly to a NAPL. In some embodiments, emulsion compositions of the present invention find use in formation of a permeable reactive barrier. In some embodiments, emulsion compositions of the present invention find use in formation of a reactive treatment zone.

Gum Arabic

In some embodiments, emulsions comprise gum arabic. Gum arabic (GA), a natural, non-toxic material produced from hardened tree sap of Acacia senegal, Acacia seyal or Acacia polyacantha, is frequently employed in the food industry for stabilization and encapsulation, as well as control of texture, viscosity, color and flavor (Dickenson (2003) Food Hydrocolloids 17:25-39; Islam et al. (1997) Food Hydrocolloids 11:493-505; Jayme et al. (1999) Food Hydrocolloids 13:459-465; Motlagh et al. (1999) Gums and Stabilisers for the Food Industry 10:53-58; each herein incorporated by reference in its entirety). GA has a complex molecular structure comprising a hydrophobic protein rich backbone to which many hydrophilic carbohydrate blocks are attached (Dickenson (2003) Food Hydrocolloids 17:25-39; herein incorporated by reference in its entirety). At the water-oil interface, the protein groups strongly associate with the oil phase, leaving the carbohydrate blocks protruding outwards in the aqueous phase which form a physical macromolecular film around the oil droplets. Once formed, the viscoelasticity of the film can be maintained even when the emulsion is diluted, particularly when the GA to oil mass ratio is approximately 1:1 (Dickenson (2003) Food Hydrocolloids 17:25-39; herein incorporated by reference in its entirety).

### EXAMPLES

The following examples are provided in order to demonstrate and further illustrate certain preferred embodiments and aspects of the present invention and are not to be construed as limiting the scope thereof.

### Example 1

### Encapsulation of nZVI Particles Using a Gum Arabic Stabilized Oil-in-Water Emulsion Materials, Experimental Methods and Analytical Methods

Materials: Ferrous sulfate (FeSO₄.7H₂O), hydrochloric acid (HCl) (37%), sodium hydroxide (NaOH), methanol (99.9%), oleic acid and trichloroethylene (TCE) (99.9%) were supplied by Fischer Scientific. Sodium borohydride (NaBH₄) (98+%) and Gum arabic were supplied by Acros Organics. Soybean oil was purchased from MP Biochemicals. Purified water (resistivity >18.2 mΩ/cm and total organic carbon (TOC)<10 ppb) was obtained from a MilliQ Gradient A-10 station (Millipore Inc.). nZVI were synthesized by reducing ferrous ion with sodium borohydride using a method modified from that of Liu et al. ((Liu et al. (2005) Environ. Sci. Technol. 39:1338-1345; herein incorporated by reference in its entirety) and as described infra. N₂ BET surface area of the nZVI was conducted by Particle Technology Labs (Downers Grove, Ill.) using a Micromeritics TriStar 3000 static pressure surface area analyzer.

Emulsion Characterization:

Information related to the formulation and construction of the emulsion is detailed infra. Iron-free emulsions created for use in control experiments were prepared to contain similar oil-phase content as the iron containing emulsion. The ZVI content of the emulsion was quantified using an acid digestion procedure (Berge et al. (2009) Environ. Sci. Technol. 43:5060-5066; herein incorporated by reference in its entirety). Methods employed to determine the density, viscosity, interfacial tension with TCE-NAPL, as well as methods to visualize the emulsion using light microscopy were similar to those previously reported (Berge et al. (2009) Environ. Sci. Technol. 43:5060-5066; herein incorporated by reference in its entirety) and are detailed infra. Stability of emulsion at 100× dilution was assessed via light transmittance at 590 nm using a Lambda 25 spectrophotometer (Perkin Elmer, Inc.). Droplet size distributions at 1000× dilution were quantified via dynamic light scattering (DLS) using a Zetasizer NanoZS analyzer (Malvern). Dynamic light scattering measurements were accomplished at 633 nm, 173 deg. Zeta potential was measured with laser Doppler velocimetry (LDV) at 1000× dilution using the same Zetasizer NanoZS analyzer.

Emulsion Reactivity:

Iron containing emulsion (˜40 g) was added to a series of 120 mL glass serum bottles inside an argon filled glove box. All batch experiments were performed in triplicate with iron controls constructed using the blank emulsion. Subsequent to the addition of ˜15 mmol of TCE (with the exception of TCE control systems), reactors were sealed and rotated on LabQuake™ end-to-end shakers at 8 RPM. Headspace gas in the reactors were sampled successively, and analyzed for hydrogen and TCE using GC-TCD and GC-FID, respectively. Details of the GC methods are included infra. Phases were assumed to be in equilibrium given the large surface area represented by the emulsion droplets, and the rapid partitioning reported for completely mixed reactors (Gossett et al. (1987) Environ. Sci. Technol. 21:202-208; herein incorporated by reference in its entirety). The relevant partition coefficients for TCE and H₂ are 351 L_{aq}/Lₒᵢₗ (Pfeiffer et al. (1005) Water Res. 39:4521-4527; herein incorporated by reference in its entirety) and 0.08 L_{aq}/Lₒᵢₗ respectively. Henry's coefficients for TCE and H₂ are 0.083 L_{aq}/L_{gas} (Gossett et al. (1987) Environ. Sci. Technol. 21:202-208; herein incorporated by reference in its entirety) and 51.1 L_{aq}/L_{gas}, respectively (Lide et al. (2008) Handbook of Chemistry and Physics, 99^{th} ed., CRC Press, Boca Raton, Fla.).

Iron Particle Synthesis: 20 g of FeSO₄.7H₂O was dissolved in 1 liter of 30% (v) methanol solution by stirring with stand-mixer under 400 rpm (Ika RW-20). Then 10 mL of 5 N NaOH solution was added drop wise to the continuously stirred (400 rpm) ferrous solution to adjust the pH to 10. Six g of NaBH₄ was dissolved in 50 ml water, and was added at a rate of 2 drops per second (from a 250 mL separatory funnel) to the ferrous solution which was vigorously mixed (600 rpm). After adding all the NaBH₄ solution, mixing continued for 20 minutes to facilitate the reaction and liberation of hydrogen gas. The suspension was allowed to settle before decanting the majority of the aqueous phase. The remaining iron containing liquid was centrifuged in a Beckman-Coulter Avanti J-25 centrifuge at 6000 rpm for 10 min at a temperature of 22° C. The subsequent supernatant was discarded yielding an iron paste. A sample of the iron paste was dried under N₂ for 12 hr at 120° C. to determine the iron content in the paste.

Analytical Methods:

To analyze the reactor headspace, 200 μL samples of gas were taken with a Becton-Dickinson 500 μL gas-tight syringe, and injected into a HP 5890 Series II GC equipped with both flame ionization detector (FID) and thermal conductivity detector (TCD) with nitrogen as carrier gas. In the GC the sample path was split to two columns: an HP-MOLSIV (30 m length, 0.53 mm inner diameter, 50 μm film thickness) leading to the TCD, and an HP-PLOTQ (30 m length, 0.53 mm inner diameter, 40 μm film thickness) leading to the FID. Column head pressure was maintained at 15 psi. Inlet temperature was 220° C., and the detector temperatures were 150° C. for TCD, and 250° C. for FID. Oven temperature was maintained at 50° C. for 4 minutes, then ramped up to 160° C. at 50° C./min and hold for 4 minutes, then increased to 230° C. at 25° C./min and hold for 7 minutes, and finally increased to 240° C. at 10° C./min and hold for 6 minutes. Hydrogen was quantified using the TCD, while TCE, ethene, ethane, acetylene, methane, 1,1-dichloroethene, cis-dichloroethene, propene, propane, 1-butene, 2-butene, and butane were quantified using the FID. Gas standards were acquired from Matheson Trigas, with the exception of H₂ which was acquired from AirGas.

Emulsion Formulation:

Oleic acid is commonly employed to stabilize ferro-fluids and used here to suspend the iron for transfer to the soybean oil (e.g., (Bashtovoy et al. (1987) Introduction to Thermomechanics of Magnetic Fluids, Hemisphere Publishing Corp.)). Ten mL of oleic acid was added to the iron paste obtained from the synthesis and vortexed for 1 min (Fisher Vortex Genie 2). The iron-containing oleic acid was subsequently added to 40 mL of soybean oil, the major components of which are linoleic acid (53% wt) and oleic acid (23% wt) (Gunstone (2004) The Chemistry of Oils and Fats: Sources, Composition, Properties and Uses, Blackwell Publishing Ltd.), and was sonicated with an ultrasonic dismembrator (Fisher Scientific Model 500) for 1.5 min at 100% output (400 W) to evenly disperse the nZVI particles in oil. The resulting iron containing oil (subsequently referred to as iron oil) was subsequently mixed with 160 g water and 200 g of 20% GA solution, and blended at room temperature for 6 minutes with a homogenizer (Omni International General Lab Homogenizer) at maximum output (700 W). The 20% GA solution was prepared by dissolving GA powder in water under mild stirring (˜120 rpm) over night, to make sure GA was fully hydrated.

Emulsion Characterization:

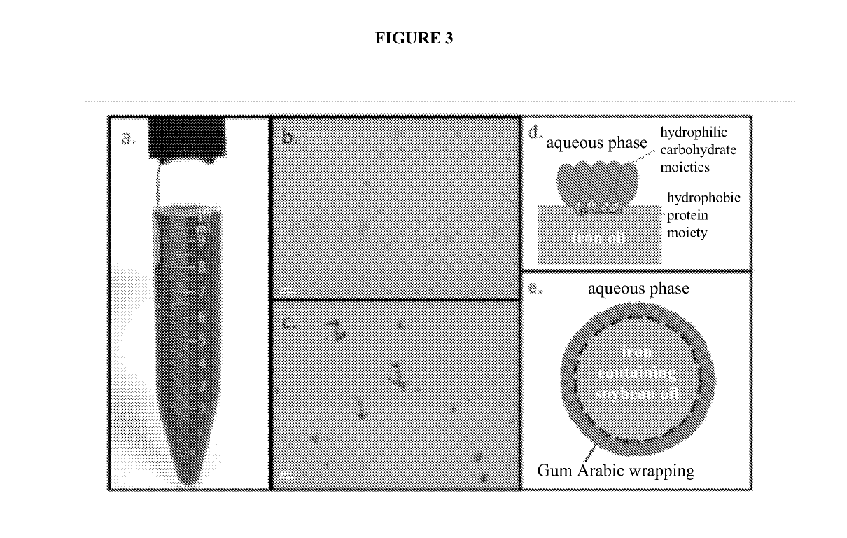

Densities were measured at room temperature (22±2 deg C.) using 25 mL glass pycnometers that were calibrated with MilliQ water prior to each use. Viscosity was measured of a range of shear rates (0.4-100 s⁻¹) using an AR-G2 rheometer (TA Instruments) with a stainless steel concentric cylinder geometry. Interfacial tension (IFT) between emulsion and TCE was quantified after 60 sec of contact using a drop shape analyzer (IT-Concept., Inc.). Bright field microscope pictures were taken with a Zeiss Axiovert S100 inverted microscope equipped with a 32× objective to confirm the droplet size and morphology. Images from the light microscopy analysis are shown in FIG. 3.

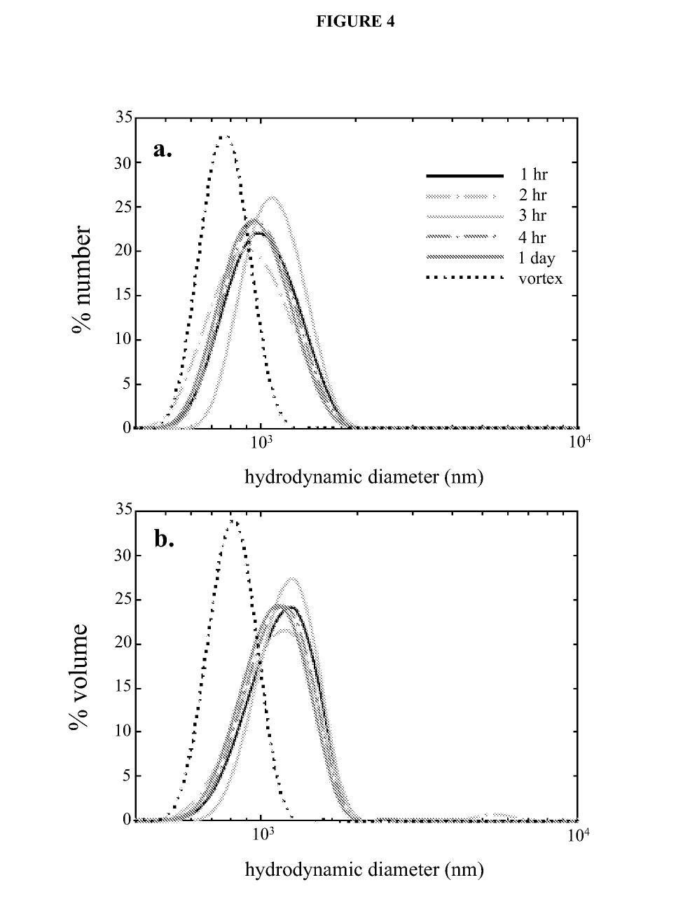

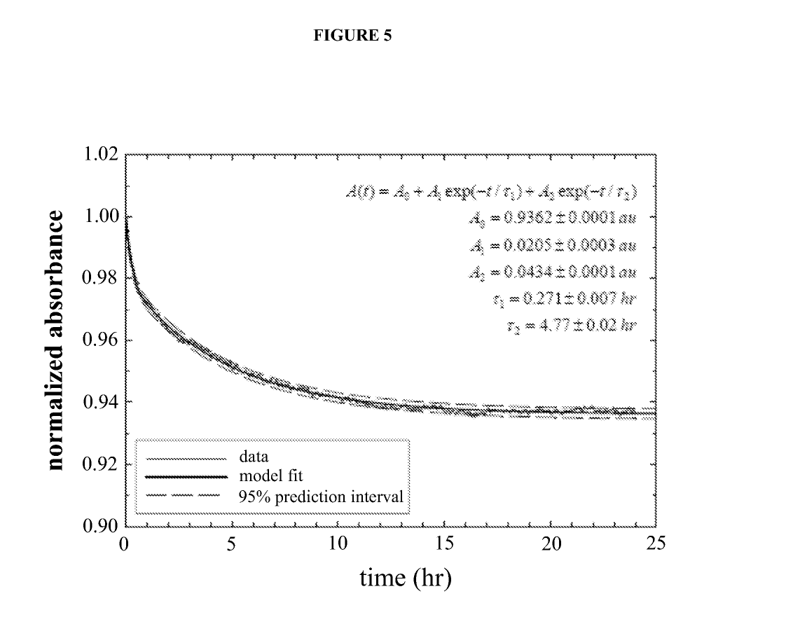

Droplet size distributions obtained via DLS are shown as a function of time on, number and volume bases in FIG. 4. These droplet size distributions are produced from the intensity measurements using an exponentially decaying, standard autocorrelation coefficient that is related to the hydrodynamic diameter through the Stokes-Einstein equation. Emulsion stability was assessed by monitoring absorbance at 580 nm over the period of 24 hr. The settling curve (FIG. 5) was modeling using a similar method as that employed by Nicolosi et al. ((2005) J. Phys. Chem. B 109:7124-7133; herein incorporated by reference in its entirety). The modeled conceptualizes the suspension as comprising settling and nonsettling fractions to obtain time constants for the sedimentation process. Absorption of light is assumed to be linearly related to particle concentration. The light absorption for a suspension having n fractions can be described by (Nicolosi et al. (2005) J. Phys. Chem. B 109:7124-7133; herein incorporated by reference in its entirety):

$$\text{?} = \text{?} + \text{?} \text{?} \\ \text{?} \text{indicates text missing or illegible when filed} \qquad ( Equation 1 )$$

where AT is the measured, total absorption normalized by the absorption at t=0, A0 is the normalized absorption from the non-settling part, Ai is the normalized absorption from the ith fraction at time zero, t is time, and Ti is a characteristic time scale for the settling of the ith fraction. When there is only one settling fraction, Equation 1 can be rearranged into a linear form:

$$ln ( \text{?} - \text{?} ) = - \text{?} + ln \text{?} \\ \text{?} \text{indicates text missing or illegible when filed} \qquad ( Equation 2 )$$

Equation 2 indicates that a plot of ln(AT-A0) versus t for a suspension containing i number fractions should contain i linear regions. Equation SI-E1 was fit to the absorbance data, assuming that the emulsion comprises a nonsettling fraction and two settling fractions, using a nonlinear least squares fitting approach executed in SigmaPlot. The nonsettling fraction represents droplets exhibiting kinetic stability over a time scale much greater than the 24 hr period examined during the stability assessment. Fitted parameters and their standard error are shown in FIG. 5.

### DLVO Calculations:

A parameter summary for DLVO calculations is shown in Table 1.

TABLE 1
Parameter summary for DLVO calculations.

| Parameter | Value | Units | Description |
|---|---|---|---|
| a | 2.5 × 10⁻⁷ | m | iron oil core radius |
| | 5.0 × 10⁻⁷ | | |
| k_{B} | 1.38065 × 10⁻²³ | $\frac{J}{K}$ | Boltzman constant |
| T | 295 | K | temperature |
| A_{H} | 5.00 × 10⁻²⁰ | J | Hamaker constant for oil |
| | | | oil interact in water |
| ε₀ | 8.85 × 10⁻¹² | $\frac{A \cdot s}{V \cdot m}$ | permittivity of free space |
| εᵣ | 79.99 | — | relative permittivity of |
| | | | water |
| μ₀ | 1.257 × 10⁻⁶ | $\frac{N}{{A}^{2}}$ | permeability of free space |
| ψ₀ | −4.30 × 10⁻² | V | zeta potential of droplet |
| Mₛ | 1.47 × 10⁴ | $\frac{A}{m}$ | saturation magnetization of iron oil |
| κ | 1.03869 × 10⁷ | $\frac{1}{m}$ | Debye-Huckel parameter (I = 1 × 10⁻⁵ M) |
| δ | 5.00 × 10⁻⁸ | m | Gum Arabic thickness |
| f₀ | 3 × 10⁻² | $\frac{J}{{m}^{2}}$ | interaction energy for water—drop pair |
| α_{w} | 1.93 × 10⁻¹⁰ | m | molecular size of water |
| λ₀ | 1 × 10⁻⁹ | m | decay length |
| | | | for hydration force |
| B₀ | −5 × 10⁻¹¹ | N | interfacial bending |
| | | | moment |
| C_{EL} | 0.02 × 10²¹ | $\frac{molec}{{m}^{3}}$ | number concentration of electrolyte |
| e | 1.602177 × 10⁻⁹ | C | elementary charge |
| γ | 3.0 × 10⁻² | $\frac{N}{m}$ | oil-water interfacial tension |
| Γ | 6.576 × 10¹⁶ | $\frac{molec}{{m}^{2}}$ | accumulation of GA at oil water interface |

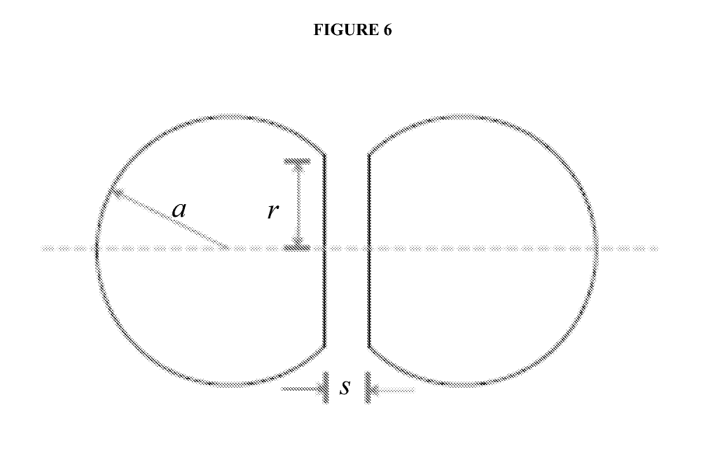

In contrast to soft particle barriers provided by grafted polymers, studies conducted on GA stabilized oil-in-water emulsions show the that the emulsion droplets can be conceptualized as having an iron oil core that is wrapped in a relatively smooth, structure inducing, viscous film of GA that is ˜50 nm thick (FIG. 3) (e.g., (Vincent et al. (1986) Colloids Surf. 18:261-281; Tan et al. (1998) in Food Flavors: Formation, Analysis, and Packaging Influences, Elsevier, Amsterdam, The Netherlands, 40:29-42; each herein incorporated by reference in its entirety). Taking the iron oil core radius as a (m) and considering the approach of two cores of size a though the beginning of core deformation (FIG. 6) indicates the need to consider multiple interactions controlling the overall energy associated with droplet approach. Van der Waal interactions for this scenario can be described (Denkov et al. (1995) J. Colloid Interface Sci. 176:189-200; herein incorporated by reference in its entirety. The Hamaker constant was estimated to be 5×10⁻² J which is a typical value for 10 to 18 carbon chain triacylglycerol oils in water (Damodaran et al. (2005) J. Food Sci. 70:R54-R66; herein incorporated by reference in its entirety). Magnetic attractive forces were modeled based upon the equation provided by Phenrat et al. (Phenrat et al. (2008) J. Nanopart. Res. 10:795-814; herein incorporated by reference in its entirety), but modified for deformation according to the process described in Petsev et al. (Petsev et al. (1995) J. Colloid Interface Sci. 176:201-213; herein incorporated by reference in its entirety). Under the assumptions that the iron oil can be modeled as a homogeneous continuum, the saturation magnetization can be estimated by volume averaging the iron oil phase (Bashtovoy et al. (1987) Introduction to Thermomechanics of Magnetic Fluids, Hemisphere Publishing Corp.). While the mass percentage of iron in the iron oil is 0.097, the volume fraction of particles φ is approximately 0.012 (nZVI particle density ρP=7.87 g/mL; iron oil density ρₒᵢₗ=1.008 g/mL). Applying a saturation magnetization for Fe⁰ of 1226 kA/m (Phenrat et al. (2008) J. Nanopart. Res. 10:795-814; herein incorporated by reference in its entirety) and 0.012 for the volume fraction of the magnetic fraction produces a saturation magnetization for the iron oil of 14.7 kA/m. Electrostatic interaction can be described as in Petsev et al. ((1995) J. Colloid Interface Sci. 176:201-213; herein incorporated by reference in its entirety). Conceptualization of the stabilized droplet wrapped in a dense GA film indicates that the steric interaction can be modeled using a general expression. Since the GA film is conceptualized as a wrapping and not as grafted soft polymer chains a general description for the steric interaction is sufficient (e.g., soft particle theory as applied by Phenrat et al. (Phenrat et al. (2008) J. Nanopart. Res. 10:795-814; herein incorporated by reference in its entirety) is not required). The key assumption behind this expression is that polymer chains act as ideal solutions (no volume change on mixing).

Hydration interactions are described in Ivanov et al. ((1999) Colloids Surf. A 152:161-182; herein incorporated by reference in its entirety). Interfacial dilatation, that is the chemical energy required to create additional interface, can be described as in Ivanov et al. ((1999) Colloids Surf. 152:161-182; herein incorporated by reference in its entirety). The repulsion associated with the physical work required to deform the interface is interfacial bending as described in Ivanov et al. ((1999) Colloids Surf. 152:161-182; herein incorporated by reference in its entirety), where the interfacial bending moment is negative for oil in water emulsions.

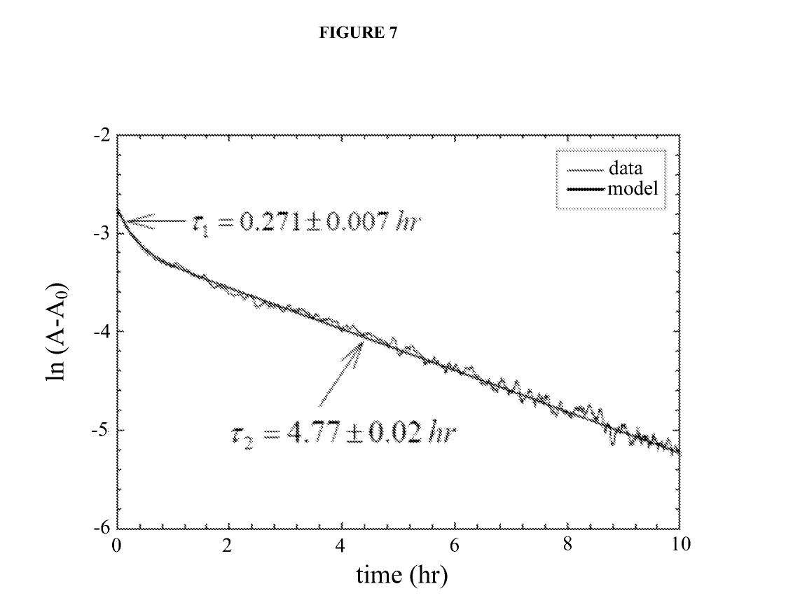

The theory of reversible coagulation (aggregation as described herein) is applied to quantitatively assess if the droplets aggregated in the secondary minimum can overcome the potential well to produce droplet-droplet contact (at zero deformation, r=0). The energy barrier is conceptualized as a kinetic resistance to the first order rate coefficient defining transformation of a doublet in the secondary minimum to a doublet in the primary minimum (Derjaguin (1989) Theory of Stability of Colloids and Thin Films, Consultants Bureau, New York, N.Y., p. 258). This kinetic barrier is quantified through the inverse of the stability parameter, W(Derjaguin (1989) Theory of Stability of Colloids and Thin Films, Consultants Bureau, New York, N.Y., p. 258). Thus, large W implies doublets remain at the position of the secondary minimum and droplet-droplet contact is avoided. For spheres of equal radius can be defined using Honing et al. ((1971) J. Colloid Interface Sci. 36:97-109; herein incorporated by reference). Application of W with the energy diagrams shown in FIG. 7 for r=0 produce values of W that are indicative of an energy barrier that is highly competent at prohibiting droplet contact.

Comparison of Rate Coefficients

Rate coefficients reported in Table 2 infra were obtained using a weighted (inverse of standard error), non-linear, least-squares regression (within MATLAB) of headspace concentrations against the model described in Equations 3-5 infra. Data used in total trapping number analyses are shown in Table 3, and parameters used in total trapping number calculations are shown in Table 4.

TABLE 2
Fitted rate coefficients for reaction within the disrespected
phase of the GA emulsion.

| | fitted rate coefficient | surface normalized rate |
|---|---|---|
| | for reaction in | coefficient for reaction in droplet² |
| | droplet¹ k | k_{SA} |
| TCE con- sump- tion (iron) | $( 7.9 \pm 0.6 ) \times {10}^{- 2} \frac{1}{hr}$ | $( 1.5 \pm 0.1 ) \times {10}^{- 2} \frac{{L}_{oil}}{{m}^{2} \cdot hr}$ |
| TCE con- sump- tion (cata- lytic) | $( 1.1 \pm 0.2 ) \times {10}^{2} \frac{{L}_{oil}}{{mmol}_{{π}_{2}} \cdot hr}$ | $( 2.0 \pm 0.3 ) \times {10}^{- 1} \frac{{L}_{oil}^{2}}{{mmol}_{{π}_{2}} , {m}^{2} \cdot hr}$ |
| H₂ pro- duc- tion | $( 4.7 \pm 0.4 ) \times {10}^{- 2} \frac{{mmol}_{{π}_{2}}}{{L}_{oil} \cdot hr}$ | $( 8.9 \pm 0.8 ) \times {10}^{- 5} \frac{{mmol}_{{π}_{2}}}{{m}^{2} \cdot hr}$ |
| TCE deact- iva- tion | $( 2.9 \pm 0.2 ) \times {10}^{- 2} \frac{1}{hr}$ | — |

¹represents reaction rate coefficient in absence of headspace.
²specific surface area of the iron particles was determined to be 8 m²/g.

TABLE 3
Data used in total trapping number analyses (at 22 ± 3° C.).

| | | | Interfacial |
|---|---|---|---|
| | Density | Viscosity | Tension^{a} |
| System | (g/mL) | (mPa·s) | (N/m) |
| GA stabilized emulsion | 1.03 ± 0.01 | 16.8 ± 0.1 | 30.75 ± 0.02 |
| (duix work) | | | |
| Surfactant-stabilized, iron | 1.00 ± 0.03 | 2.4 ± 0.5 | 7.07 ± 0.14 |
| containing oil-in- | | | |
| water emulsion (S21) | | | |
| Surfactant-stabilized | 0.979 ± 0.0001 | 2.52 ± 0.05 | 7.2 ± 0.4 |
| macroemulsion for | | | |
| density modified | | | |
| displacement of TCE | | | |
| (S22) | | | |
| Surfactant Flood for | 0.994 ± 0.001 | 1.64 ± 0.02 | 0.19 |
| Mobilization | | | |
| (3.3% wt) Aerosol | | | |
| MA-90 + 8% (wt) | | | |
| 2-propanol + 4 g/L | | | |
| NaCl, (S23) | | | |
| Surfactant Flood for | 1.002 ± 0.001 | 1.29 ± 0.04 | 10.4 ± 0.08 |
| Solubilization | | | |
| (4% wt) Tween 80 + 0.5 | | | |
| g/L CaCl₂ (S23) | | | |
| Emulsified Zero Valent | 1.1 | 1942 | 37.5 |
| Iron (S24) | | | |

^{a}with TCE

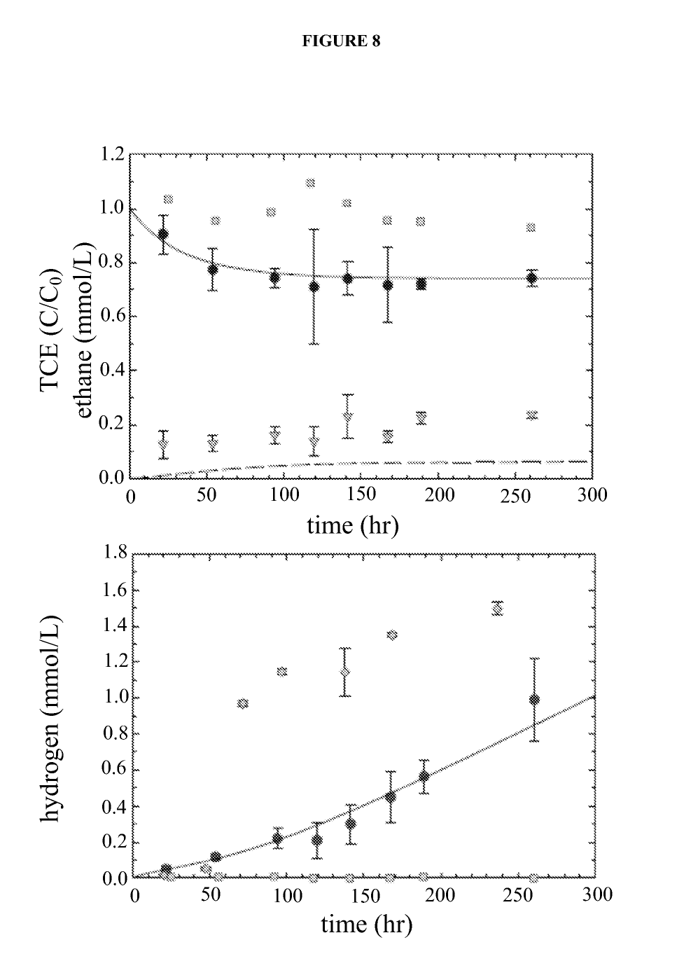

TABLE 4
Parameters utilized in total trapping number calculations.

| Parameter | Value |
|---|---|
| Relative Permeability | 1 |
| TCE-DNAPL Density | 1.46 g/mL |
| Contact angle | 0 |
| Flow direction | horizontal |

$$\begin{matrix} \text{?} = - \text{?} \text{?} - \text{?} \text{?} \text{?} \text{?} & ( Equation 3 ) \\ \text{?} = \text{?} - \text{?} \text{?} \text{?} \text{?} & ( Equation 4 ) \\ \text{?} = exp \text{?} \\ \text{?} \text{indicates text missing or illegible when filed} & ( Equation 5 )\end{matrix}$$

Where C_{TCE} and C_{H2} are the molar concentrations of TCE and H₂ in the headspace, respectively; k_{obs, TCE}, k_{obs,TCE-H2}, and k_{obs,H2} are the rate coefficients corresponding to the pseudo-first order consumption of TCE, pseudo-second order, catalytic, hydrogenation of TCE, and pseudo-zeroth order production of H₂, respectively; and k_{d} is the first-order deactivation term (Liu et al. (2005) Chem. Mat. 17:5315-5322; herein incorporated by reference in its entirety). Here the hydrogenation of TCE is assumed to proceed to ethane. Observed ethane concentrations were not used in the fitting of the kinetic model described above to the TCE and H₂ concentrations. Rather, the ethane concentrations were used as a predictive check on the amount of hydrogenation suggested by the fitted rate coefficients. Predicted ethane concentrations shown in FIG. 8 were generated using the fitted rate coefficients (Table 1) and the catalytic hydrogenation reaction represented by:

$$\text{?} = \text{?} \text{?} \text{?} \text{?} \\ \text{?} \text{indicates text missing or illegible when filed} \qquad ( Equation 6 )$$

The fitted pseudo-first order rate coefficient for the consumption of TCE (k_{obs,TCE}) was modified assuming the reaction occurs in the oil (k_{TCE}) (Burris et al. (1998) Environ. Toxicol. Chem. 17:1681-1688; herein incorporated by reference in its entirety).

$$\text{?} - \text{?} ( \text{?} ) \\ \text{?} \text{indicates text missing or illegible when filed} \qquad ( Equation 7 )$$

Where Kp is the oil-water partition coefficient of TCE, K_{H} is the Henry's coefficient for TCE, and Vₒ, V_{aq}, and V_{g} are the volumes of the dispersed, aqueous, and gas phases, respectively. In general, k can be normalized to produce k_{SA,TCE} as shown in Equation 8.

$$\text{?} = \frac{k}{\text{?} \text{?}} \\ \text{?} \text{indicates text missing or illegible when filed} \qquad ( Equation 8 )$$

Where, SSA_{Fe} is the specific surface area of the iron particles, C_{Fe oil} is the mass concentration of the iron particles in the oil.

Correction of pseudo-second and pseudo-zeroth order reactions can also be accomplished following the general procedure in Burris et al. (Burris et al. (1998) Environ. Toxicol. Chem. 17:1681-1688; herein incorporated by reference in its entirety). Considering the pseudo second order reaction occurring in the oil phase:

$$\frac{\text{?}}{\text{?}} = \text{?} \text{?} \\ \text{?} \text{indicates text missing or illegible when filed} \qquad ( Equation 9 )$$

where C_{o TCE} is the concentration of TCE in the oil and C_{o,H2} is the concentration of H₂ in the oil. It is noted the dimensions on the rate coefficient, k, are

$$\frac{\text{?}}{\text{?}} , \\ \text{?} \text{indicates text missing or illegible when filed}$$

where mol_{o,H2} is mol of H₂ in the oil. Thus, the concentration term C_{o,H2} must be corrected (in addition to the rate and C_{o TCE}, terms) by introducing an additional term in the form of

$$\frac{\text{?}}{\text{?}}$$

$$\text{?} \text{indicates text missing or illegible when filed}$$

as shown in Equation 10 with the additional step of normalization.

$$\text{?} = \frac{\text{?}}{\text{?}} ( \frac{\text{?}}{\text{?}} ) ( \frac{\text{?} + \frac{\text{?}}{\text{?}} + \frac{\text{?}}{\text{?}}}{\text{?}} ) \\ \text{?} \text{indicates text missing or illegible when filed} \qquad ( Equation 10 )$$

Similarly, the pseudo-zeroth order rate coefficient, with dimensions

$$\frac{\text{?}}{\text{?}}$$

$$\text{?} \text{indicates text missing or illegible when filed}$$

requires the addition of

$$\frac{\text{?}}{\text{?}}$$

$$\text{?} \text{indicates text missing or illegible when filed}$$

when correcting the rate coefficient, as shown in Equation 7 with the additional step of normalization.

$$\text{?} \text{?} \frac{\text{?}}{\text{?}} ( \frac{\text{?}}{\text{?}} ) ( \frac{\text{?} + \frac{\text{?}}{\text{?}} + \frac{\text{?}}{\text{?}}}{\text{?}} ) \\ \text{?} \text{indicates text missing or illegible when filed} \qquad ( Equation 11 )$$

For the purposes of comparison, the pseudo-first order rate coefficient for the consumption of TCE can be modified to an equivalent aqueous phase rate coefficient by assuming the reaction occurs in a single phase. Thus,

$$\frac{\text{?}}{\text{?}} \text{?}$$

$$\text{?} \text{indicates text missing or illegible when filed}$$

in the oil phase is assumed to be the same as in the hypothetical, equivalent aqueous phase (aqe).

$$\frac{\text{?}}{\text{?}} \vert \text{?} \text{?} \frac{\text{?}}{\text{?}} \vert \text{?} \\ \text{?} \text{indicates text missing or illegible when filed} \qquad ( Equation 12 )$$

Defining the rate in both phases produces Equation 13. [symbol]
Where C_{Fe,aq} is the mass concentration of iron in the hypothetical, equivalent aqueous phase. Rearranging Equation 23, and substituting Kp for the ratio of concentrations produces Equation 12 assuming the mass of iron in the aqe is the same as the mass in the oil phase.

[symbol]

Considerations for Application of Emulsions in DNAPL Source Zones

Delivery of remedial amendments within DNAPL source zones utilizes consideration of several important physical properties—density, viscosity and interfacial tension. The density of the GA emulsion is 1.03±0.01 g/mL at 22±2° C. Because small differences in density between the injected and resident fluids can result in gravity over- or under-ride of the zone targeted for treatment (e.g., Taylor et al. (2004) J. Contam. Hydrol. 69:73-99; herein incorporated by reference in its entirety) the present GA emulsion is a compromise between delivery and iron loading. Additional iron loading would increase density, and consequently the complexity of any hydraulic design aimed at uniformly distributing the iron within the subsurface. Measurement of the viscosity of the GA emulsion as a function of shear rate (0.4-100 s⁻¹) at 20.00±0.01° C. indicates the emulsion may be weakly shear thinning, but that a Newtonian assumption may provide a reasonable approximation (FIG. 1). At 20.00±0.01° C. and 10 s⁻¹ the emulsion viscosity is 16.8±0.1 mPa-s. Viscosity of the injected fluid is important from both an energy and mobility perspective. Delivery of the GA emulsion will require ˜20× more head per unit transport length than that required by water to maintain the same rate of flow. In a fine sand material having intrinsic permeability of 10⁻⁸ cm² and porosity of 0.38, a hypothetical treatment (groundwater) velocity of 1 m/day will require 76 cm of head for a transport distance of 10 m. This energy input should be readily attainable, even in shallow unconfined aquifers.

This potential for mobilization (as determined using the total trapping number of Pennell et al. (19960 Environ. Sci. Technol. 30:1328-1335; herein incorporated by reference in its entirety) can be visualized in a novel format shown in FIG. 2. The range of intrinsic permeability shown on the x-axis represents permeability for which injection/flushing is most applicable (silty sands to gravel). The utility of FIG. 2a lies in the regions defined under the elbow curves that represent conditions consistent with limited (N_{T}=2×10⁻⁵) and complete (N_{T}=1×10⁻⁴) DNAPL mobilization. In general, the horizontal extent of the curve is related to the IFT between the solution and NAPL (higher IFT solutions are better suited for higher permeability formations) while the vertical extent of the curve is related to the ratio of IFT to the viscosity of the flushing solution (higher viscosity solutions are restricted to using lower treatment velocities). The calculations shown in FIG. 2b indicate that the GA emulsion finds use for broad applicability within DNAPL source zones (as determined by the area under the curve).

Results

Emulsion Stability

The iron containing oil-in-water emulsion created during the experiment detailed herein was a dark-grey, opaque fluid (FIG. 3a) comprising GA (10.0% wt), soybean oil (9.0% wt), oleic acid (2.2% wt), iron (1.2% wt), methanol (0.4% wt) and water (77.2% wt). The Fe⁰ content of the emulsion (12 g/L), confirmed by acid digestion, was greater than the iron content often used for subsurface remediation applications (1-10 g/L) (Berge et al. (2009) Environ. Sci. Technol. 43:5060-5066; Kirschling et al. (2010) Environ. Sci. Technol. 44:3474-3480; each herein incorporated by reference in its entirety). Visual inspection of the GA stabilized emulsion indicated kinetic stability in excess of four hours (i.e., no discernible phase separation was observed during this time frame).

Destabilization over longer time (4 day) was found to occur via sedimentation (dispersed phase (iron oil+GA) density was 1.15 g/mL) with ˜20% volume observed at the bottom of the tube containing the emulsion. Sedimented emulsion droplets were readily resuspended by inverting the tube indicating limited coalescence (emulsions broken through coalescence require much greater energy input to reform the large surface area represented by suspended droplets) (Becher et al. (2001) Emulsions: Theory and Practice, 3^{rd} ed, Oxford University Press, Washington, D.C.). Light microscopy examination of diluted suspended phase showed droplet sizes of ˜1 μm and smaller (FIG. 3b) which compared favorably to the number average droplet diameter (1.03 μm) obtained from DLS (FIG. 4). In addition, aggregates of nZVI particles were not observed in any sample, indicating that the iron remained encapsulated within the dispersed phase.

Encapsulation of nZVI particles was further confirmed by the microscope images of the diluted settled phase (FIG. 3c) where larger droplets were found among chains of smaller droplets. The observation of aggregated droplets, particularly those having diameters of several microns, indicated an attractive magnetic body force between ferromagnetic dipoles. The images in FIG. 3 also indicate that, in contrast to surfactant stabilized iron-containing emulsion (Berge et al. (2009) Environ. Sci. Technol. 43:5060-5066; herein incorporated by reference in its entirety), coalescence of oil droplets was suppressed by the GA film. The presence of droplet chains in the sedimented fraction and the absence of coalescence indicates that the emulsion was destabilized by aggregation of the iron-containing oil droplets, though the sedimentation occurred over a much longer time than that reported for aqueous suspensions of iron particles (Phenrat et al. (2008) J. Nanopart. Res. 10:795-814; Sun et al. (2007) Colloids and Surfaces a-Physicochemical and Engineering Aspects 308:60-66; each herein incorporated by reference in its entirety). These visual observations were confirmed by examining the potential for droplet coalescence and aggregation in more detail.

To explore the potential role of coalescence, a time course of droplet size distributions was obtained via DLS with sampling occurring after gently inverting the tube 3-4 times to eliminate the potential influence of sedimentation. Results of the time series are shown in FIG. 4, where the similarity between the droplet size distributions though the observation period suggested that coalescence had little role in destabilizing this emulsion. Coalescence (e.g., the rupture of droplet membranes to form one, larger droplet) would have resulted in a substantial increase in the frequency of the largest droplets. This was not evident even in the droplet size distributions plotted on a percent volume basis (which accentuates the presence of large droplets). To further explore the potential role of coalescence, the emulsion was vortexed (Fisher Vortex Genie 2) for 1 min following the 24 hr sample to produce a number average droplet diameter of 0.78 μm. The input of the large quantity of energy provided by the vortexer resulted in a small change in the droplet size distribution, indicating few coalesced droplets are present after one day. The observed stability against coalescence in the presence of the magnetic attraction between the iron oil cores of the droplets results from the structural stability provided by the GA film.

Droplet sedimentation was quantitatively examined using light transmission over a 24 hr period, with a quasi-steady state found around 16 hr (FIG. 5). As visual assessment of emulsion stability indicates destabilization occurs over the period of days, it appears there is a fraction of the emulsion which slowly settles (e.g., between 16 hr and 4 day). Nicolosi et al. ((2005) J. Phys. Chem. B 109:7124-7133; herein incorporated by reference in its entirety) modeled similar behavior by conceptualizing the suspension as comprising settling and non-settling fractions to obtain time constants for the sedimentation process. Following this approach two sedimenting populations and one nonsedimenting population were identified during experiments detailed herein. In contrast to studies employing linearization schemes to determine the time constants associated with particle/droplet settling, Equation 1 were fit to the data set using a non-linear least squares approach (FIG. 5). Time scales for the sedimenting fractions were found to be τ₁=0.271±0.007 hr and τ₂=4.77±0.02 hr, which are shown in FIG. 7 in a manner that better visualizes the two settling populations. While the present invention is not limited to any particular mechanism, and an understanding of the mechanism is not necessary to practice the present invention, it is contemplated that the short time scale process results from sedimentation of the large droplets shown to be present in both the light microscopy and DLS analyses. Consideration of the longer time scale process begins to make apparent one benefit of emulsion encapsulation—slower gravitational destabilization. Sedimentation studies conducted for similar (or lower) iron mass loadings produced time scales on the order of minutes (Phenrat et al. (2007) Environ. Sci. Technol. 41:284-290; Phenrat et al. (2008) J. Nanopart. Res. 10:795-814; Sun et al. (2007) Colloids and Surfaces a-Physicochemical and Engineering Aspects 308:60-66; each herein incorporated by reference in its entirety) which are indicative of a faster sedimentation process. The time scales quantified herein show a significant enhancement to the stability of nZVI. This enhancement in stability coupled with the observation that gentle mixing re-stabilizes the emulsion shows that GA emulsion stabilizes the iron particles over time-scales consistent with transport through porous media (Berge et al. (2009) Environ. Sci. Technol. 43:5060-5066; Ramsburg et al. (2004) J. Contam. Hydrol. 74:105-131; each herein incorporated by reference in its entirety).

The time scale for sedimentation quantified herein is a phenomenological description of a complex settling process. To better understand the role of aggregation in the gravitational destabilization of the emulsion, a highly simplified Stokes law analysis is considered for purposes of illustration. An isolated, rigid droplet that is 1 μm in size (ρ=1.15 g/mL) settling though an otherwise quiescent aqueous phase (ρ=1.00 g/mL and μ=1.00 mPa-s) attains steady-state velocity of ˜7 mm/d Considering this slow, albeit ideal, sedimentation velocity with the observation of aggregates in the sedimented fraction of the light microscopy analysis (FIG. 3c), while the present invention is not limited to any particular mechanism, and an understanding of the mechanism is not necessary to practice the present invention, it is contemplated that the destabilization observed over the first 16 hr of the study resulted from droplet aggregation which hastened sedimentation. In addition, it is hypothesized that the nonsedimenting fraction of the emulsion represents a size fraction that is kinetically stable against the coupled aggregation-sedimentation process.

To explore the hypotheses related to aggregation and sedimentation illustrative, like-like interactions between 600 nm and 1100 nm droplets were qualitatively assessed using extended DLVO theory for deformable emulsion droplets (Ivanov et al. (1999) Colloids Surf. A 152:161-182; Denkov et al. (1995) J. Colloid Interface Sci. 176:189-200; Petsev et al. (1995) J. Colloid Interface Sci. 176:201-213; each herein incorporated by reference in its entirety). Details of the DLVO analysis including equations and all parameter values are described herein. The analysis included Van der Waals (VW) and magnetic (M) attractive interactions with electrostatic (ES), steric (St), interfacial dilatation (S), interfacial bending (B), and hydration (H) repulsive interactions. Of these interactions, hydration, interfacial dilatation and interfacial bending are all short range forces that become important when assessing the potential for droplet deformation. The shape of aggregated droplets is important because deformed droplets represent strong aggregation on an energetic path toward coalescence (e.g., film rupture) (Petsev et al. (1995) J. Colloid Interface Sci. 176:201-213; herein incorporated by reference in its entirety). Droplet deformation, as assessed by the dimension associated with the flattening of the interface (r, see FIG. 6), occurs when attractive forces (Van der Waals and magnetic) are stronger than long range repulsive forces (electrostatic and steric) and those forces resulting from increased interfacial area (hydration, interfacial dilatation, and interfacial bending).

DLVO was performed with deformation (r) and separation (s) normalized by the radius of the iron-oil core (a) (see FIG. 3d-e for conceptual model of the droplets). Calculations indicated that the minimum energy condition lies at zero deformation for both droplet sizes. This can be seen in the contour plot of deformation versus separation by the energy valley (s=431 and 181 nm for the 600 and 1100 nm diameter droplets, respectively) that extends to the zero deformation condition (r=0) (30). The absence of deformation in these calculations is consistent with the lack of coalescence seen in the DLS measurements and indicates that the GA structure provides a competent physical-chemical barrier against the strong magnetic attraction. The barrier to droplet contact creates a near infinite stability parameter, which indicates that the energetic barrier is large enough to effectively prevent irreversible aggregation in the primary minimum (Derjaguin et al. (1989) Theory of Stability of Colloids and Thin Films, Consultants Bureau, New York, N.Y., p 258). Reversible aggregation, however, may still occur in the secondary minimum. In the case of the 600 nm diameter droplet, the secondary minimum (˜−40 kT) occurs at long range (431 nm). The large separation distance and zero deformation indicates that aggregates of 600 nm droplets are relatively weak and overcome by mixing, which is consistent with the observation of slow sedimentation (Becher et al. (2001) Emulsions: Theory and Practice, 3^{rd} ed., Oxford University Press, Washington, D.C., p. 513; Petsev et al. (2005) J. Colloid Interface Sci., 176:201-213; each herein incorporated by reference in its entirety). In contrast, the secondary minimum associated with 1100 nm droplets represents a strong attractive force (˜−1340 kT) that may lead to more rapid aggregation and settling—an assessment that is supported the observation of chains and clusters of relatively large droplets in the sedimented fraction (FIG. 3c). The droplet size distributions (FIG. 4) do not appear to be consistent with the extent of aggregation expected from the strong, albeit theoretical, interaction calculated using extended DLVO theory. While the present invention is not limited to any particular mechanism, and an understanding of the mechanism is not necessary to practice the present invention, it is contemplated that this inversion process was sufficient to separate the flocculated droplets—a hypothesis that is supported by observations that the settled emulsion could be resuspended.

Reactivity Screening

A series of batch experiments was designed to quantify apparent rate coefficients for the four phase system (headspace, dispersed phase (oil droplets), continuous phase (aqueous phase) and iron particles) assuming the reaction occurs within the dispersed phase. Headspace data for both TCE and H₂ shown in FIG. 8 (averages of triplicate reactors) demonstrate reactivity in comparison with the relevant control reactors (no iron and no TCE). The data indicate that over the ˜300 hr monitoring period, 4 mmol TCE was consumed in presence of between 17 and 24 mmol e- (range established by assuming Fe⁰ goes to Fe (II) and Fe (III), respectively). Rate coefficients shown in Table 2 supra were obtained from simultaneous, weighted (inverse of standard error from triplicate reactors) fit to the reaction data. Details of the model employed to obtain the fitted parameters are provided herein. In brief, data were modeled by coupling reactions for pseudo first-order consumption of TCE, and pseudo-zero order production of hydrogen (given that the water content in the oil remains constant under the assumption of equilibrium partitioning). In addition, a pseudo-second order, hydrogenation reaction was included based upon the observation that boron may catalyze a reaction between H₂ and TCE (Liu et al. (2005) Environ. Sci. Technol. 39:1338-1345; herein incorporated by reference in its entirety). Modeling results indicate approximately half of the 160 μmol H₂ produced were subsequently consumed in the hydrogenation reaction. Total ethane production, estimated using Kow values for the soybean-oil partition coefficient (Sangster (1997) Octanol-Water Partition Coefficients: Fundamentals and Physical Chemistry, Wiley, New York, N.Y., p 170; herein incorporated by reference in its entirety) to be 25 μmol, is consistent with this amount of hydrogenation. Little production of ethane occurred beyond what was predicted by the hydrogenation reaction (FIG. 8) indicating that coupling pathways are enhanced within the soybean oil. Liu et al. (2005) Environ. Sci. Technol. 39:1338-1345; herein incorporated by reference in its entirety) found that coupling products (C3-C6) accounted for up to 30% of the TCE mass degraded in aqueous phase systems. While the present invention is not limited to any particular mechanism, and an understanding of the mechanism is not necessary to practice the present invention, it is contemplated that lack of products observed in experiments described herein resulted from formation of a broad distribution of coupling products that remained below the quantification limits due to partitioning (reactors contained three fluid phases). Computational and experimental studies that report a 0.5 log unit increase in Kow for each carbon addition demonstrate the affinity of coupling products for the oil and support this hypothesis (Sangster (1997) Octanol-Water Partition Coefficients: Fundamentals and Physical Chemistry, Wiley, New York, N.Y., p 170; Garrido et al. (2009) J. Chem. Theory Comput. 5:2436-2446; each herein incorporated by reference in its entirety). It is interesting that water remains reactive within the emulsion (as evidenced by the production of H₂) even as the reaction with TCE slows. This indicates that: sites responsible for catalyzing the conversion of TCE may be passivated (no effect on H₂ production, just decrease in H₂ consumption); reactive sites on the iron surface remain accessible to water after becoming inaccessible to TCE (water can transport through porous oxides (Wang et al. (2003) Environ. Sci. Technol. 37:3891-3896; herein incorporated by reference in its entirety)); or both.

Comparison of surface normalized rate coefficients to those reported for aqueous suspensions of iron particles must consider the capacity that the oil droplet has for chlorinated solvents. The TCE rate coefficient within the oil droplets can be shown to be equivalent to an aqueous phase rate coefficient of ˜5×10⁻³ L_{aq}/m²-hr (Equations E14-E16) which is similar to rate coefficients reported for bare iron particles (Liu et al. (2005) Environ. Sci. Technol. 39:1338-1345; Liu et al. (2007) Environ. Sci. Technol. 41:7881-7887; Song et al. (2008) Appl Catal. B 78:53-60; each herein incorporated by reference in its entirety). The emulsion, however, is ˜10% oil, indicating that conversion within the emulsion is equivalent to an aqueous phase rate coefficient of ˜5×10⁻⁴ L_{aq}/m²-hr. Thus, the rate of TCE conversion in the emulsion system compares favorably to rates observed in aqueous suspensions of polymer-coated iron particles (Quinn et al. (2005) Environ. Sci. Technol. 39:1309-1318; Phenrat et al. (2009) Environ. Sci. Technol. 43:1507-1514; each herein incorporated by reference in its entirety).

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in environmental remediation or related fields are intended to be within the scope of the following claims.

We claim:

1. An emulsion composition comprising nanoscale zero valent iron (nZVI) particles, said nanoscale zero valent iron particles comprising elemental iron (Fe⁰) said emulsion comprising soybean oil, and gum arabic, wherein the concentration of said Fe⁰ in said emulsion is at least 3 g/L.

2. The composition of claim 1, wherein said emulsion has density between 0.95 and 1.05 g/mL and viscosity <20 cP.

3. The composition of claim 1, wherein said emulsion composition is free of surfactants.

4. The composition of claim 1, wherein the concentration of Fe⁰ in said emulsion is at least 10 g/L.

5. The composition of claim 1, wherein said nZVI particles are uncoated.

6. The composition of claim 1, wherein said emulsion exhibits a sedimentation time of 4 hours or greater.

7. A method of neutralizing environmental contaminants within non-aqueous phase liquid comprising contacting a non-aqueous phase liquid (NAPL) comprising an environmental contaminant with the emulsion composition of claim 1, wherein said contacting neutralizes said environmental contaminant.

8. The method of claim 7, wherein said contacting causes chemical reduction of said environmental contaminant within said NAPL.

9. The method of claim 7, wherein said NAPL is a dense non-aqueous phase liquid (DNAPL).

10. The method of claim 7, wherein said environmental contaminant is selected from the group consisting of halogenated methanes, ethanes, ethenes and benzenes.

11. The method of claim 10, wherein said halogenated group is selected from the group consisting of carbon tetrachloride, chloroform, trichloroethene, and trichloroethane.

12. The method of claim 7, wherein said environmental contaminant is dechlorinated.

13. The method of claim 7, wherein said NAPL comprises more than one distinct environmental contaminant.
